(19) United States
(12) Patent Application Publication
(10) Pub. No.: US 2010/0208408 A1
(43) Pub. Date: Aug. 19, 2010

(54) Light-Activated Switch and Circuit for Select-Fire Perforating Guns

(75) Inventors: Lyle G. Love, Weatherford, OK (US); Sanford E. Stark, Weatherford, OK (US); Frank L. Lezu, JR., Weatherford, OK (US); John R. Harris, Weatherford, OK (US); Jason C. Mailand, The Woodlands, TX (US); Brian S. Buffington, Watherford, OK (US)

Correspondence Address: BURLESON COOKE L.L.P., 2040 NORTH LOOP 336 WEST, SUITE 123, CONROE, TX, 77304, US

(73) Assignees: Tejas Research and Engineering, LP, The Woodlands, TX (US); Casedhole Solutions, Inc., Weatherford, OK (US)

(21) Appl. No.: 12/371,432

(22) Filed: Feb. 13, 2009

(51) Int. Cl. H01H 47/24

(52) U.S. Cl. 361/175

(57) ABSTRACT

Apparatus and method are provided for selectively firing apparatus in a well when the apparatus is fired by an electrical voltage and produces light upon firing. A photoresistor or other device changes in an electrical property when the light from firing of a section of the apparatus impinges on the photoresistor or other electronic device. The change in electrical property shifts the state of a relay such that the following section of the device can be fired with a voltage of the opposite polarity to that used in firing the preceding section. A test and resetting apparatus for the select-fire apparatus is also provided.

### BACKGROUND OF INVENTION

1. Field of the Invention

This invention relates to well operations. More particularly, apparatus and method are provided for selective firing of explosive devices with a light-activated switch.

2. Description of Related Art

Casings in wells for producing or injecting fluids are cemented in a wellbore and holes are formed in the casing at selected locations opposite certain subterranean formations by a device called a “perforating gun.” The gun usually is made up of shaped charges that are detonated by a blasting cap. The cap is activated by an electrical current. In many wells it is desirable to perforate casing over larger distances in the wellbore than can be accommodated by one perforating gun. To avoid running perforating guns in the wellbore and withdrawing the spent charges repeatedly, it is advantageous to place a plurality of perforating charges or groups of charges in the well simultaneously and shooting the charges selectively when placed opposite the selected subterranean formation. This capability is called “select-fire,” and it is old in the art.

Examples of apparatus for selectively firing perforating charges are disclosed in U.S. Pat. Nos. 5,531,164; 5,700,969; and 7,387,162. The electrical circuits in the devices are designed such that charges are fired sequentially by alternately applying a negative and a positive electrical voltage to the device. The circuits also include a mechanical device, referred to as a “dart.” The dart is disposed between chambers of a perforating charge or multiple charges that are to be fired selectively. The function of the dart is to electrically ground a blasting cap in the adjacent second chamber when the charges are fired in a first chamber. The electrical circuits are such that the perforating charges cannot be fired until the blasting cap for those charges is grounded. The dart moves in response to the shockwave pressure in the first chamber to place electrical conductors in contact, thus grounding the blasting cap. Darts may be made of aluminum or steel and may have rubber or other electrical insulation. A simplified drawing of a dart, to illustrate the principles of operation, is shown in FIG. 1 (Prior Art). The explosive force of perforating charges puts electrical conductors in contact.

One problem with darts is that about 1 in 120 devices now in use in industry fail and cause a misfire (lack of firing) of subsequent charges in a sequence of select-fire charges. This failure requires that the perforating apparatus be withdrawn from a well and another apparatus run into the well. This can be a very costly failure, particularly in deep wells, offshore wells and other wells in high-cost operating areas. Another limitation of mechanical darts is that there is no adequate test to predict the performance of a dart before it is used.

Other explosive devices may be used in wells where firing at selected times and places is advantageous. For example, explosive devices may be used to cut casing or other tubulars, to obtain a sample of material surrounding a well or for other purposes.

What is needed is a device to be used in an electrical circuit to replace the mechanical darts and an electrical circuit to be used with the device such that select-firing of devices can be achieved by alternating the electrical voltage applied to the device between positive and negative. Tests to predict the performance of the device before it is run into a well should be available.

### BRIEF SUMMARY OF THE INVENTION

A select-fire device is provided employing a light-activated sensor to switch the position of a relay. Light to activate the device is produced by the ignition and burning of explosive materials in the perforating gun. A first perforating charge or charges in a first chamber can be fired by applying a DC voltage of selected polarity, for example, negative. A window disposed between the first chamber and the adjacent second chamber, each containing a perforating charge or multiple charges that are to be fired selectively, allows light from the first chamber to pass to a switch. The light passing into the switch decreases the resistance of a photoresistor in the switch. The decrease in resistance allows shifting of a relay to the position such that the charges above the switch (in the second chamber) can be fired by a voltage of opposite polarity—in the example positive. Successive switches between chambers containing perforating charges, each with a window, photoresistor and relay, allow the select-firing of an arbitrary number of charges or sets of multiple charges. Other explosive devices may be fired at selected places and times using the apparatus and method disclosed herein. A test device is provided that may be used to reset the respective switch relays for reuse (of the device) or to verify that the circuit is operable before deploying the select-fire device in a well.

### BRIEF DESCRIPTION OF THE SEVERAL VIEWS OF THE DRAWING(S)

FIGS. 1A and 1B are simplified drawings illustrating operating principles of a prior art mechanical switch.

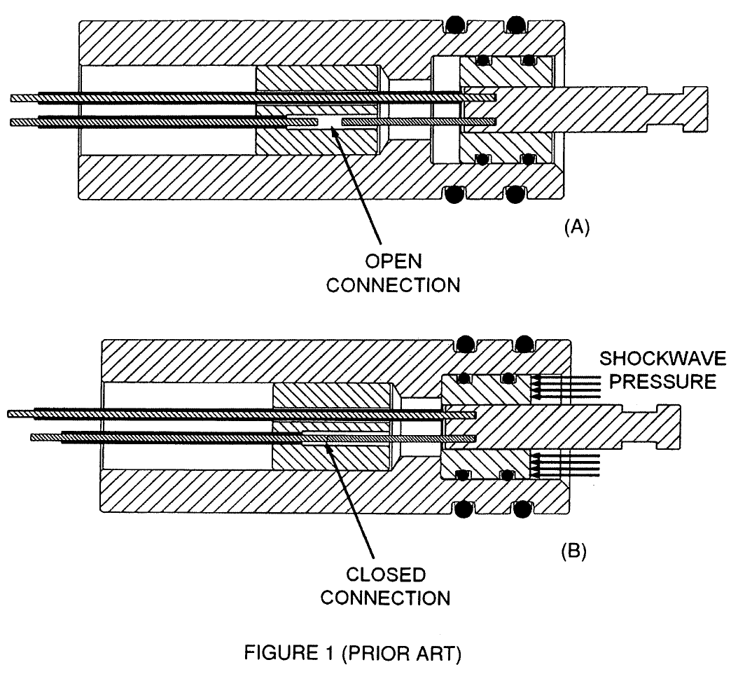

FIG. 2 is an electrical schematic of one embodiment of a circuit employing light-activated sensors in a select-fire device.

FIG. 3 is an electrical schematic of a negative switch

FIG. 4 is an electrical schematic of a positive switch

FIG. 5 is an assembly drawing of a select-fire perforating apparatus.

FIG. 6 is an isometric quarter-section view of one embodiment of the optical switch disclosed herein.

FIG. 7 is an electrical schematic of a test and resetting circuit device showing the resetting of a negative switch.

### DETAILED DESCRIPTION OF THE INVENTION

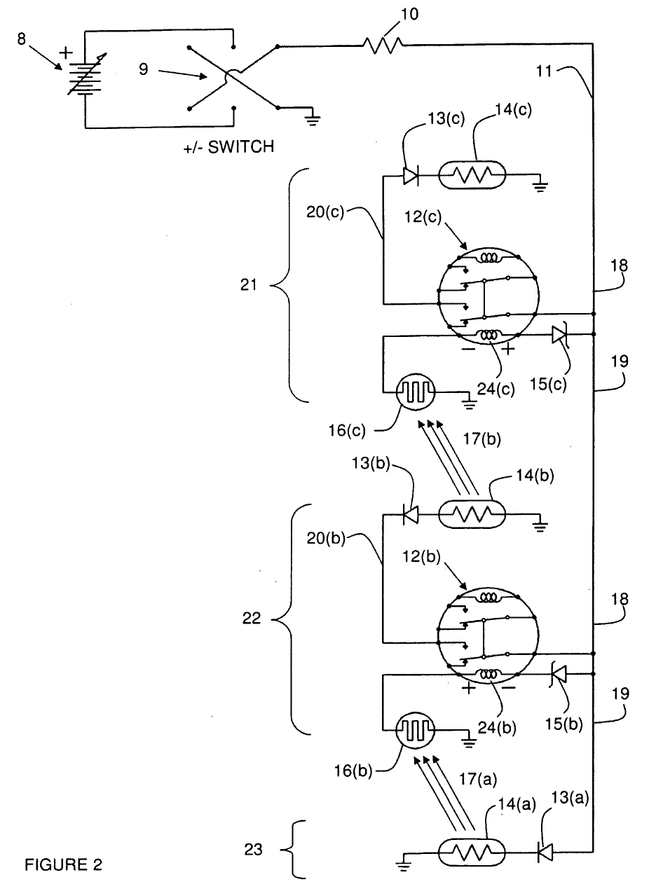

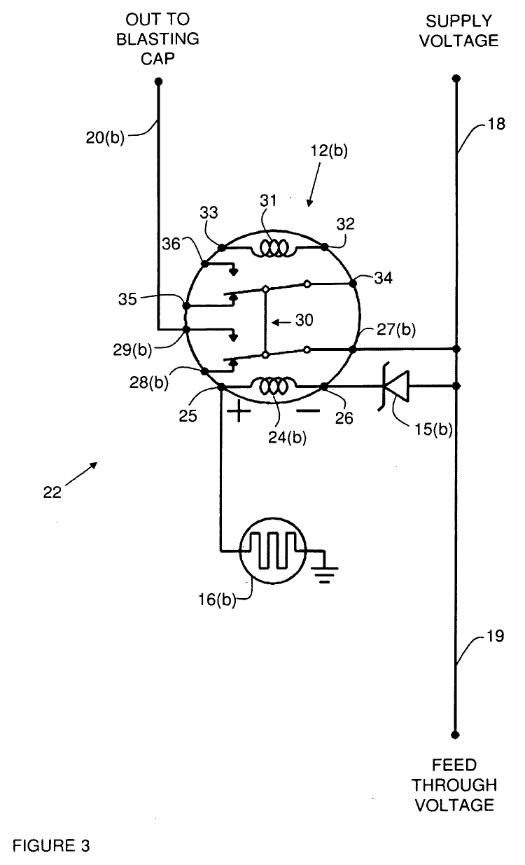

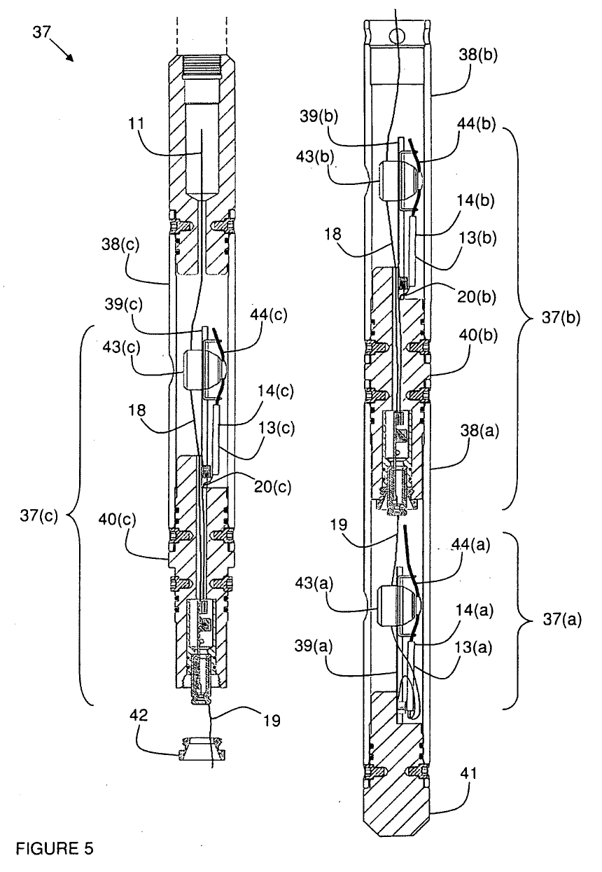

Referring to FIG. 2, one embodiment of an electrical circuit for use with a light-activated switch as disclosed herein is shown. Variable voltage power supply 8, preferably capable of supplying from 0 to about 65 VDC, is used in conjunction with voltage polarity switch 9 to send either positive or negative voltage down supply voltage line 11 to a perforating gun assembly such as assembly 37 (FIG. 5) during a well casing perforation operation. Supply voltage line 11 has inherent line resistance 10, which usually is in the range from 20 to about 200 ohms. Several gun sections or more could be used during any given perforating operation; however, in this embodiment, a single positive switch (21), a single negative switch (22), and a section without a switch (23) are discussed. These switches control the firing of charges in three sections of perforating gun assembly 37 of FIG. 5. To initiate a select-fire perforating operation, a negative voltage of approximately 30-50 VDC is applied to supply voltage line 11. The negative voltage allows current to flow through blasting cap diode 13(a) of section 37(a), the lowest blasting section of perforating gun assembly 37. The current causes blasting cap 14(a) to ignite primacord 44(a), firing all lower perforating guns 43(a) in section 37(a) of the tool. While perforating guns 43(a) are firing, the negative voltage is applied across Zener diode 15(b) of negative switch 22, coils 24(b) of relay 12(b) and photoresistor 16(b) to ground. The resistance of photoresistor 16(b) is high, preferably in the range of about 200 k ohms, until light 17(a) from perforating gun 43(a) or blasting cap 14(a) or primacord 44(a) reaches photoresistor 16(b), when the resistance drops to a low resistance—in the range of about 3 k ohms, for example. The low resistance of photoresistor 16(b) allows sufficient current to flow through relay switching coil 24(b) and Zener diode 15(b) to shift the state of dual switch latching relay 12(b). Referring to FIG. 3, relay switching wiper connection 27(b), connected to input supply voltage line 18, is switched from the normally closed switching wiper connection 28(b) to the normally open switching wiper connection 29(b). The switching within relay 12(b) of negative switch 22 allows supply voltage line 18 to be in direct contact with next blasting cap wire 20(b). Once the polarity of the supply voltage line 18 is switched through voltage polarity switch 9, current is allowed to flow in a positive direction through blasting cap wire 20(b) and blasting cap diode 13(b) of negative switch 22 to blasting cap 14(b), which ignites primacord 44(b) and perforating guns 43(b) section 37(b) of perforating gun assembly 37. While positive voltage is applied to the supply voltage line 11 and perforating guns 43(b) of negative switch 22 are firing, the positive applied voltage is applied across Zener diode 15(c) of positive switch 21. Again, the high resistance of photoresistor 16(c) embedded within positive switch 21 and behind a protective lens, as will be shown in detail below, prevents any significant current from passing through Zener diode 15(c) and switching coil 24(c) of dual switch latching relay 12(c). Once light 17(b) from the perforating gun 43(b) or blasting cap 14(b) or primacord 44(b) reaches photoresistor 16(c) of positive switch 21, the resistance of photoresistor 16(c) drops, allowing sufficient current to flow through relay switching coil 24(c) and Zener diode 15(c) to shift the relay from the normally closed wiper connection to the normally open switching wiper connection. The switching within relay 12(c) of positive switch 21 allows supply voltage line 18 to be in direct contact with next Zener diode 13(c) and blasting cap wire 14(c). This process is continued until all of the switches are sequenced and the blasting caps fired.

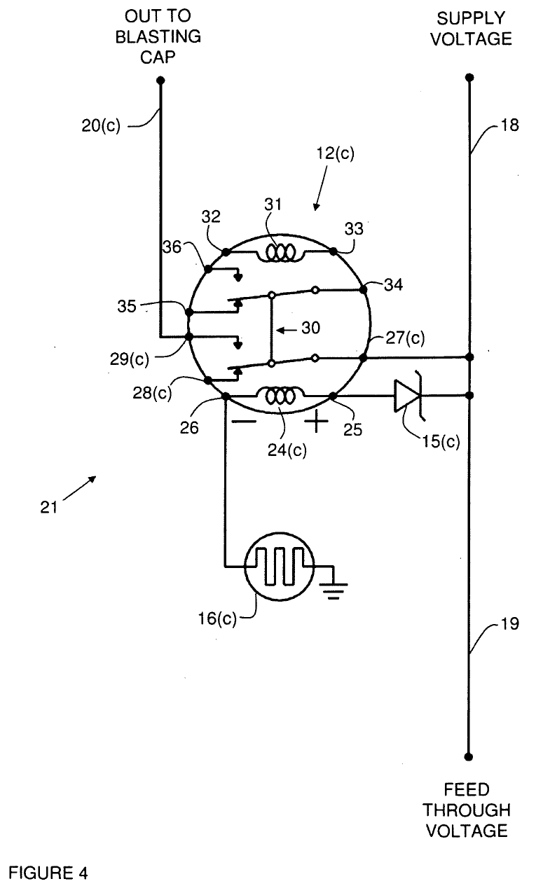

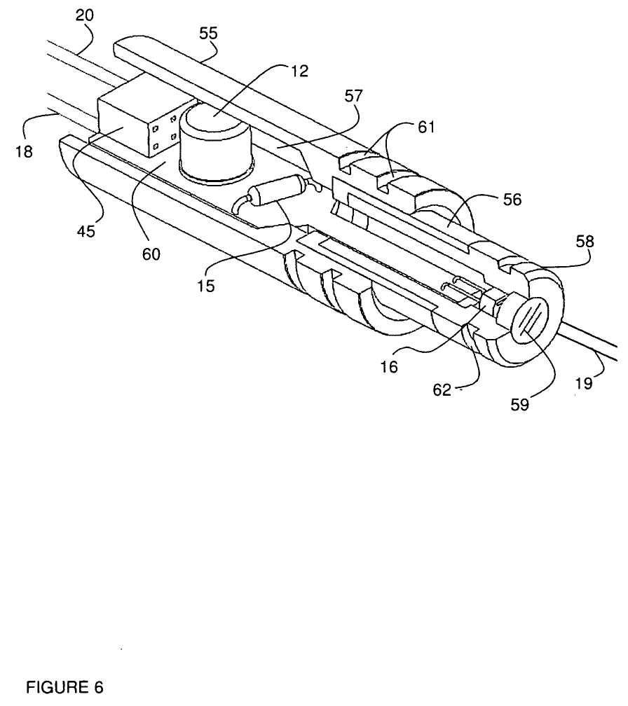

Referring to FIGS. 3, 4, 5 and 6 one embodiment of the electrical schematics of a negative switch 22 (FIG. 3) and a positive switch 21 (FIG. 4) and the corresponding mechanical structures (FIGS. 5 and 6) are shown in more detail. Incoming supply voltage wire 18 is connected to voltage pass-through wire 19 of negative switch 22 within perforating gun assembly 37. Voltage pass-through wire 19 is connected to pass-through voltage connection 58 (FIG. 6) on the nose of positive switch 21. Dual switch latching relay 12 has two distinct sides, switching and resetting. Relay switching coil 24 is used to change the state of the switch and allow direct contact between supply voltage line 18 and the next blast cap wire 20. The other side of the dual switch latching relay 12, relay resetting coil 31, is used to verify the state of the latch and reset the switch. Both relay switching wiper connection 27 and relay resetting wiper connection 34 are directly connected internally through switching and resetting wiper link 30. One side of dual switch latching relay 12 cannot be activated without activating the other side. The same discussion applies to the electrical schematic of positive switch 21 referred to in FIG. 4. The main differences between the electrical schematics of negative switch 22 in FIG. 3 and positive switch 21 in FIG. 4 is the polarity of Zener diode 15.

Referring to FIG. 5, one embodiment of select-fire perforating gun assembly 37 is shown. From the top of perforating gun assembly 37, supply voltage line 11 is connected to supply voltage wire 18 of positive switch 21 in section 37(c). Voltage pass-through wire 19 is connected to the pass through voltage connection 58 at the end of positive switch 21. Voltage pass-through wire 19 is connected to supply voltage wire 18 of negative switch 22 located in section 37(b) of perforating gun assembly 37. Voltage pass-through wire 19 of negative switch 22 is connected to blasting cap diode 13(a) of the last gun section within the tool. Below the last negative switch 22 of perforating gun assembly 37 are perforating gun(s) 43(a), perforating gun tube 38(a), perforating gun holder 39(a), primacord 44(a), blasting cap 14(a), and blasting cap diode 13(a). Between the last negative switch 22 and the first positive switch 21 of perforating gun assembly 37 are perforating gun(s) 43(b), perforating gun tube 38(b), perforating gun holder 39(b), primacord 44(b), blasting cap 14(b), and blasting cap diode 13(b). Above the first positive switch 21 of perforating gun assembly 37 are perforating gun(s) 43(c), perforating gun tube 38(c), perforating gun holder 39(c), primacord 44(c), blasting cap 14(c), and blasting cap diode 13(c). Perforating gun assembly 37 body is made up of gun assembly nose 41, perforating gun tubes 38(a)-(c), and switch holder subs 40(a) and (b). Positive and negative switches are held within respective switch holder subs by switch retaining nuts 42. Perforating gun tubes 38 are sealed with o-rings and secured with bolts to the switch holder subs. Perforating gun assembly 37 can have as many alternating switches as necessary for the particular perforating operation. The supply voltage is dependent on perforating gun characteristics and perforating gun assembly 37 configuration.

Referring to FIG. 6, an isometric quarter-section view of one embodiment of the optical switch disclosed herein is shown. Switch body 55 can be made of steel or aluminum. Switch body 55 has o-ring grooves 61 that allow the switch to seal explosive pressure to switch holder sub 40 and within perforating gun tube 38 (FIG. 5) during perforating operations. The voltage passed down to the next sequential switch is made through pass-through connection component 58 on the end of the switch. Pass-through connection component 58 has wire wrap groove 62 for attaching a voltage pass-through wire for the next successive switch. Located within pass-through connection component 58 is photoresistor 16 that is connected to printed circuit board 60 within switch body 55. Also attached to printed circuit board 60 are Zener diode 15, dual switch latching relay 12, and switch test connector 45. Printed circuit board 60 and all of the electrical components are preferably held in place with non-conducting potting material 57. Photoresistor 16 may be protected from explosive debris by protective window 59. Window 59 may be made of high-strength glass or other optically transparent material. Electrical isolation between the pass-through connection component 58 and the switch body 55 is provided by voltage insulator 56, which is typically made from polyetheretherketone (PEEK) or another similar non-conducting material.

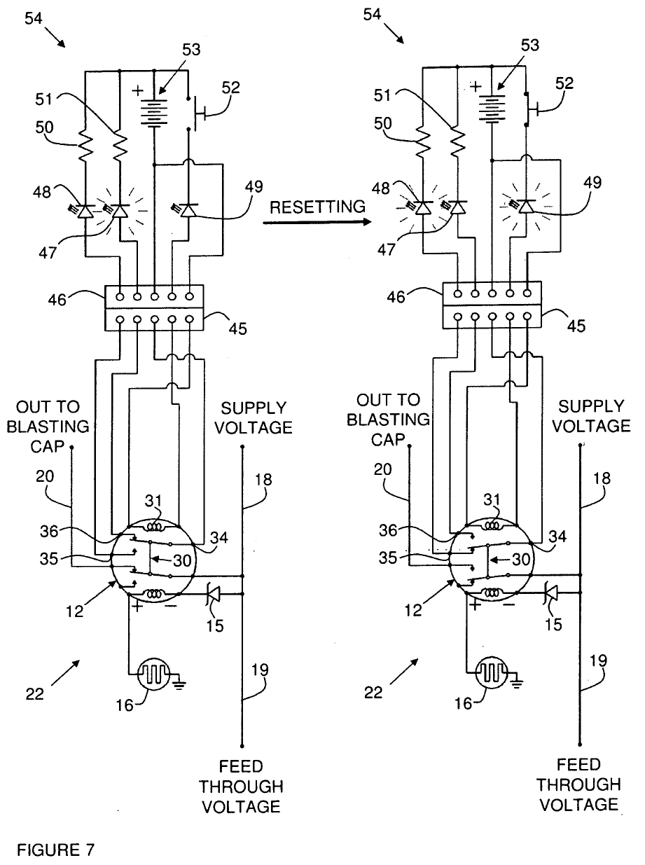

Referring to FIG. 7, an electrical schematic of test and resetting circuit device 54 is shown during the process of resetting negative switch 22 from the “fired” to the “armed” state. The left hand side of FIG. 7 shows dual switch latching relay 12 of negative switch 22 in the “fired” state. After use in the perforating gun assembly 37, negative switch 22 can be reset and reused. Test and resetting circuit device 54 can be connected through test circuit connector 46 to switch test connector 45 (FIG. 6) mounted on printed circuit board 60 within the negative switch 22, for example. The same applies for positive switch 22. Once test and resetting circuit device 54 is connected to a “fired” negative switch 22, red “fired” light emitting diode (LED) 47 is illuminated by current passing through a circuit made through DC power supply 53, test circuit connector 46, switch test connector 45 and relay resetting wiper connection 34 on the dual switch latching relay 12, out to normally-open resetting wiper connection 36, back to switch test connector 45, test circuit connector 46, through LED 47, and 2 k ohm resistor 51. Resetting of the negative switch 22 dual switch-latching relay 12 is accomplished by depressing the normally-open push button switch 52. When push button switch 52 is depressed, it completes two circuits. The first circuit allows current to flow through push button switch 52, the green “reset” light emitting diode (LED), test circuit connector 46, switch test connector 45, relay positive resetting coil connection 32, relay resetting coil 31 on the dual switch latching relay 12 of negative switch 22, through the relay negative resetting coil connection 33, back to the switch test connector 45, into the test circuit connector 46 and into the negative side of the 16-24 VDC power supply 53. This circuit allows relay resetting coil 31 to switch the relay switching wiper connection 27 and relay resetting wiper connection 34 connected through the switching and resetting wiper link 30, from the “fired” state to the “armed” state. Once relay resetting coil 31 is energized, the “armed” circuit is completed. The “armed” circuit is made when LED 48 is illuminated by current passing through a circuit made through DC power supply 53, test circuit connector 46, switch test connector 45, relay resetting wiper connection 34 on the dual switch latching relay 12, out to the normally-closed resetting wiper connection 35, back to switch test connector 45, test circuit connector 46, through LED 48, and 2 k ohm resistor 51. Once dual switch latching relay 12 is in this final state, illustrated on the right-hand side of FIG. 7, negative switch 22 is ready for removal of the test and resetting circuit device 54 and loading within the perforating gun assembly 37.

A suitable relay for the disclosed apparatus is model 422H dual switch latching relay available from Teledyne, Inc. A suitable Zener diode is NTE5251A, 9.1 Zener Voltage, available from NTE Electronics, Inc. or 1N5262 51 Zener Voltage, available from Vishay Semiconductors. The range depends on the shooting voltage of the perforating assembly. A suitable photoresistor, having a resistance in darkness of 200 k ohm and 3 k ohm in light, is PVD-P8001, available from Advanced Photonix, Inc.

The method and apparatus disclosed herein have been described primarily as activating perforating guns. It should be understood that the method and apparatus may also be employed to activate other devices by electrical current when light is produced. For example, selective firing of apparatus to cut pipe, recover a core sample or other material from a well using an explosive, or any other operating employing an explosive charge may be accomplished using the method and apparatus disclosed herein.

Although a mechanical dual switch latching relay has been described above, it should be understood that a single switch, non-latching may be employed instead. Also, solid state electronic switching devices, well known in the art, may be used instead of a mechanical relay. Also, a decrease in resistance of a photoresistor is described in the apparatus and method disclosed herein, but a change in resistance or other electrical property of a material in response to light may also be employed in some embodiments of the method disclosed. A change in electrical resistance, both positive and negative, in response to light may be employed in the method disclosed herein. A change in electrical capacitance or inductance or electrostatic charge of an electrical circuit in response to light may be used to shift the position or state of a mechanical or electronic relay in the method disclosed herein.

Although the present invention has been described with respect to specific details, it is not intended that such details should be regarded as limitations on the scope of the invention, except to the extent that they are included in the accompanying claims.

We claim:

1. Apparatus for selectively activating a device in a well in response to a light, comprising:
a diode adapted to pass electrical current in response to a positive or a negative voltage;
a device to produce a change in an electrical characteristic in response to the light; and
a relay connected so as to change from a first state to a second state in response to the change in an electrical characteristic when the positive or the negative voltage is applied across a connection in series of the diode, a first coil of the relay and the device to produce a change in an electrical characteristic in response to light.

2. The apparatus of claim 1 wherein the device in a well is a perforating gun.

3. The apparatus of claim 1 wherein the diode is a Zener diode.

4. The apparatus of claim 1 wherein the device to produce a change in an electrical characteristic in response to light is a photoresistor.

5. The apparatus of claim 1 wherein the relay is a latching mechanical relay.

6. The apparatus of claim 1 further comprising a switch body, the switch body enclosing a mounting for the diode, the device to produce a change in an electrical characteristic in response to light and the relay, and having a window adapted for passing light from outside the switch body to the device to produce a change in an electrical characteristic in response to light.

7. The apparatus of claim 6 wherein the relay is a dual switch relay and further comprising a switch test connector.

8. A method for selectively firing of a section of a device, comprising:
providing the apparatus of claim 6;
joining the apparatus of claim 6 between a second section of the device and a first section of the device so as to place the window to pass light from the first section of the device when the first section of the device is fired; and
applying a voltage having a first polarity to a line to fire the first section of the device.

9. The method of claim 8 further comprising providing the apparatus of claim 6, joining the apparatus of claim 6 between a third section of the device and the second section of the device so as to place the window to pass light from the second section of the device when the second section of the device is fired; and
applying a voltage having a second polarity to the line to fire the second section of the device.

10. The method of claim 8 wherein the device is a perforating tool.

11. Apparatus for testing or resetting the apparatus of claim 7, comprising:
a test circuit connector;
a DC power supply;
a light to indicate electrical current flow through a dual switch latching relay when the relay is in a selected state;
a switch to connect the power supply to a second coil of the relay; and
a light to indicate electrical current flow through the second coil of the relay.
